(19) United States
(12) Patent Application Publication
(10) Pub. No.: US 2002/0089940 A1
(43) Pub. Date: Jul. 11, 2002

(54) Duplexing apparatus and method in large scale system

(75) Inventor: Dong-Jun Lee, Daegukwangyeok-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 09/973,376

(22) Filed: Oct. 9, 2001

(30) Foreign Application Priority Data
Jan. 6, 2001 (KR) 863/2001

(51) Int. Cl. H04B 1/44

(52) U.S. Cl. 370/282; 714/11

(57) ABSTRACT

Disclosed is a duplexing method in a system duplexed into a first unit and a second unit. The first unit includes a first processor and a first local memory, and the second unit includes a second processor and a second local memory. The method according to the present invention comprises the steps of: providing a duplexing channel for concurrently accessing and selectively accessing the first local memory and the second local memory between the first unit and the second unit; providing a duplexing control logic section accessible to the first local memory and the second local memory through the duplexing channel; and concurrently accessing the first local memory and the second local memory through the duplexing channel by the duplexing control logic section based on a request for memory accessing by an active processor, which is either the first processor or the second processor.

### PRIORITY

This application claims priority to an application entitled “Duplexing Apparatus and Method in Large Scale System” filed with the Korean Industrial Property Office on Jan. 6, 2001 and assigned Ser. No. 2001-863, the contents of which are hereby incorporated by reference.

### BACKGROUND OF THE INVENTION

1. Field of the Invention

The present invention relates generally to a duplexing apparatus and a duplexing method in a large scale system, and in particular, to a duplexing apparatus and a duplexing method in a large scale system for continuing operation during a system failure.

2. Description of the Related Art

A large scale system adopts a duplexing method as a prerequisite to realizing a failure tolerance. The processor duplexing method is classified into a synchronized duplexing (hot standby) method and an asynchronized duplexing (warm or cold standby) method. The synchronized duplexing method identically operates both processors by synchronizing a micro-level unit, an instruction unit, or a process instance. The synchronized duplexing method has an advantage of quicker recovery time from an error, when occurred, by identically operating both processors. However, operating both processors in the synchronized duplexing method creates a drawback in that a system load is increased. Alternatively, the asynchronized duplexing method operates only one of the two processors, and when the active processor is in trouble, succeeding the operation by the standby processor. Although the asynchronized duplexing method has an advantage in that the system has a smaller load than the synchronized duplexing method, it also has some drawbacks. The asynchronized duplexing method has difficulties in maintaining the consistency of data between the two processors as well as in rapidly reconfiguring and recovering the data when an error has occurred.

When designing a large system with high reliability, it is necessary to minimize deterioration of the system performance while realizing the consistent maintenance of data and rapid reconfiguration and recovery of data with a minimal software load. A duplexing apparatus and method are also necessary to decrease the load of the applicable software that is becoming larger and more complicated in a system.

### SUMMARY OF THE INVENTION

It is, therefore, an object of the present invention to provide a duplexing apparatus and method for maintaining the consistency of data as well as for rapid reconfiguration and recovery of data in times of trouble with a minimized load on software, for realizing a failure tolerance and minimizing the deterioration of a system performance.

It is another object of the present invention to provide a duplexing apparatus and method that decreases the load of applicable software that is becoming larger in the system.

To achieve the above objects, a duplexing method comprising a first unit and a second unit is provided. The first unit includes a first processor and a first local memory, and the second unit includes a second processor and a second local memory. The method comprises: providing a duplexing channel for concurrently and selectively accessing the first local memory and the second local memory between the first unit and the second unit; providing a duplexing control logic section to access the first local memory and the second local memory through a duplexing channel; and concurrently accessing the first local memory and the second local memory through the duplexing channel by the duplexing control logic section upon request of a memory access by an active processor, which is either a first processor or a second processor.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a duplexing apparatus according to an embodiment of the present invention;

FIG. 2 is a block diagram illustrating a detailed construction of the duplexing apparatus according to an embodiment of the present invention;

FIG. 3 is an example of a memory map in a local memory; and

FIG. 4A is a flow chart illustrating a control for duplexing according to an embodiment of the present invention.

FIG. 4B is a continuation of the flow chart illustrated in FIG. 4A.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

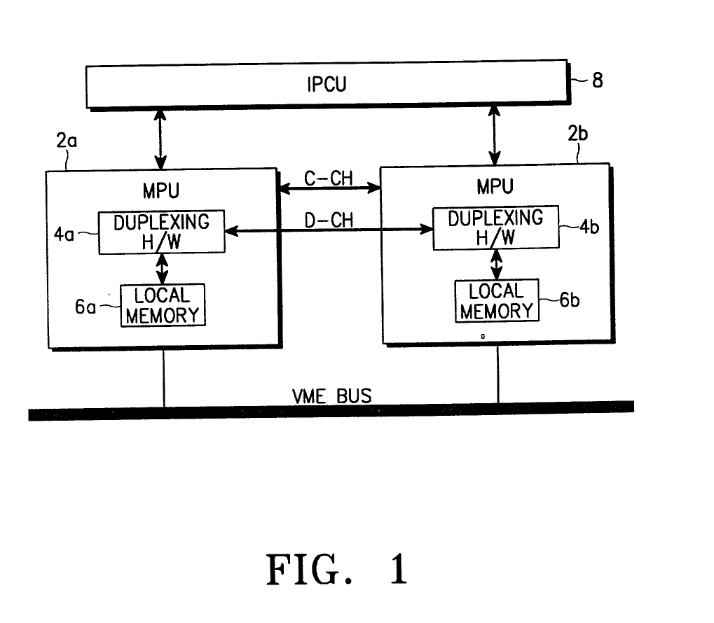

FIG. 1 is a block diagram illustrating a duplexing apparatus according to an embodiment of the present invention. Referring to FIG. 1, two main processor units (MPU) 2a, 2b are housed in a system to correct reliability and availability of the system. One of the two MPUs 2a, 2b is in active mode, while the other is in standby mode. The two MPUs 2a, 2b are connected by a versa module Europa Bus (VME BUS). Inter processor communication unit (IPCU) 8, which is an interface for communication between the two MPUs 2a, 2b and another processor but is irrelevant to an aspect of the present invention, will not be described here in further detail.

The duplexing apparatus according to an embodiment of the present invention realizes maintaining the consistency of data as well as rapid reconfiguration and recovery of data in times of trouble with a minimized load on software while realizing a failure tolerance and minimizing deterioration of a system performance. For that purpose, according to an embodiment of the present invention, the MPUs 2a, 2b comprise duplexing hardware sections 4a, 4b, which have the same constructions as the MPUs 2a, 2b. A data channel D-CH, which is a duplexing channel, and a control channel C-CH are connected between the MPU 2a and MPU 2b. The duplexing channel composed of the data channel D-CH and the control channel C-CH are the channels used for concurrently writing data in the local memories 6a, 6b provided within the MPUs 2a, 2b.

To be more specific, the data channel D-CH is a channel used for transferring data, an address and a related control signal while concurrently writing data in the local memory 6b. The control channel C-CH is a channel used for active/standby negotiation and exchange of information between the duplexed MPUs 2a, 2b. The control channel C-CH also transmits and receives signals informing on the status of the duplexed connection as well as signals informing in the start and termination of a duplexing cycle for control in a hardware manner after the negotiation.

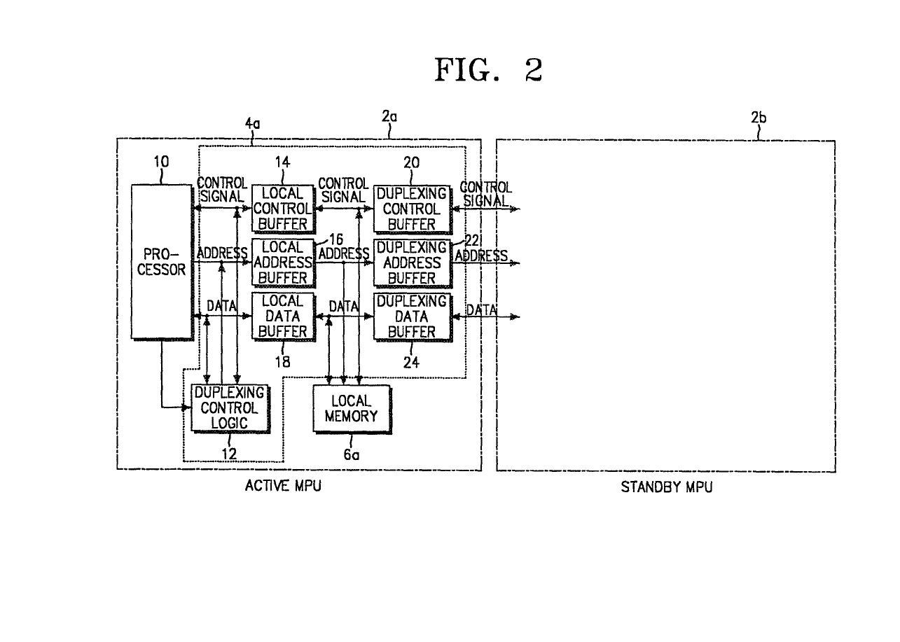

FIG. 2 is a block diagram illustrating a detailed construction of the duplexing apparatus according to an embodiment of the present invention, and particularly of the MPU 2a in FIG. 1, which is identical to the detailed construction of the MPU 2b in FIG. 2. In FIG. 2, the MPU 2a is assumed to be an active MPU, and the MPU 2b is assumed to be a standby MPU. Any one of the two MPUs 2a, 2b can be an active MPU or a standby MPU. If the MPU 2a becomes an active MPU, the MPU 2b becomes a standby MPU, and vice versa.

The duplexing hardware section 4a in FIG. 1 comprises the blocks, excluding the processor 10 and the local memory 6a, in FIG. 2. In other words, the duplexing hardware section 4a consists of a duplexing control logic 12, a local control buffer 14, a local address buffer 16, a local data buffer 18, a duplexing control buffer 20, a duplexing address buffer 22, and a duplexing data buffer 24. The data channel D-CH in FIG. 1 is formed through the lines where the control signal, address and data are transmitted and received between the duplexing control logic 12 of the MPU 2a and the duplexing control logic 12 (not shown in the drawings) of the MPU 2b. The control channel C-CH in FIG. 1 is formed through the line where the control signal is transmitted and received between the processor 10 of the MPU 2a and the processor 10 (not shown in the drawing) of the MPU 2b.

In FIG. 2, the processor 10 of the active MPU 2a controls the duplexing control logic 12, and is able to access, concurrently and one at a time, a local memory 6a of itself and a local memory 6b (not shown in FIG. 2) of the standby MPU 2b. The processor 10 performs an active/standby negotiation and exchange of information between the duplexed MPUs 2a, 2b. The control channel C-CH transmits and receives signals of the states of the MPUs 2a, 2b (i.e., active/standby state) as well as the duplexed connection states in addition to starting and terminating a duplexing cycle for control in a hardware manner after the negotiation.

The duplexing control logic 12 either enables the local control buffer 14, the local address buffer 16, the local data buffer 18, the duplexing control buffer 20, duplexing address buffer 22, and the duplexing data buffer 24 in both of the MPUs 2a, 2b, or enables the buffers of any one side only based on the memory access control of the processor 10. That is, if the duplexing control logic 12 is not accessing the memories 6a, 6b concurrently, it either accesses its own local memory 6a only or the local memory 6b of the standby MPU 2b only.

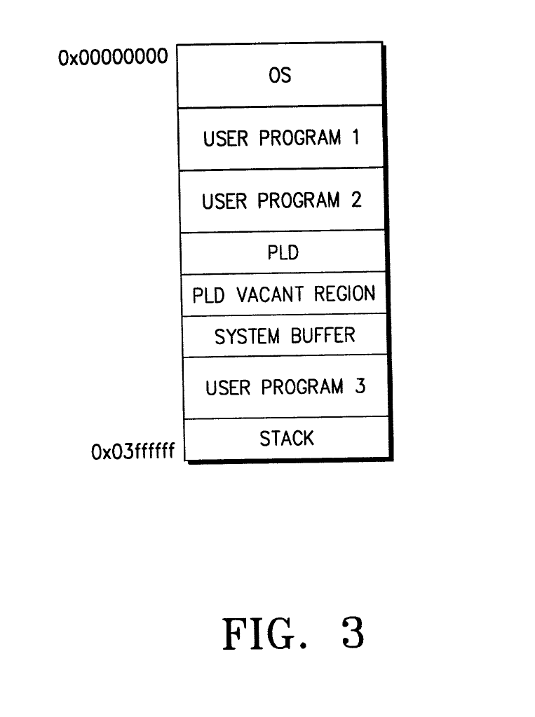

FIG. 3 is an example of a memory map in a local memory to show that a corresponding address value in the used memory region is “0x00000000˜0x03ffffff”. The active processor 10 provides the duplexing control logic 12 with an address value for memory access within the range of “0x40000000˜0x43ffffff” to concurrently access the local memory 6a itself and the local memory 6b of the standby MPU 2b. When in need of accessing the local memory 6b only of the standby MPU 2b, the active processor 10 provides the duplexing control logic 12 with an address value for memory access within the range of “0x80000000˜0x83ffffff”. When in need of accessing the local memory 6b itself only, the active processor 10 provides the duplexing control logic 12 with an address value for memory access within the range of “0x00000000˜0x03ffffff”.

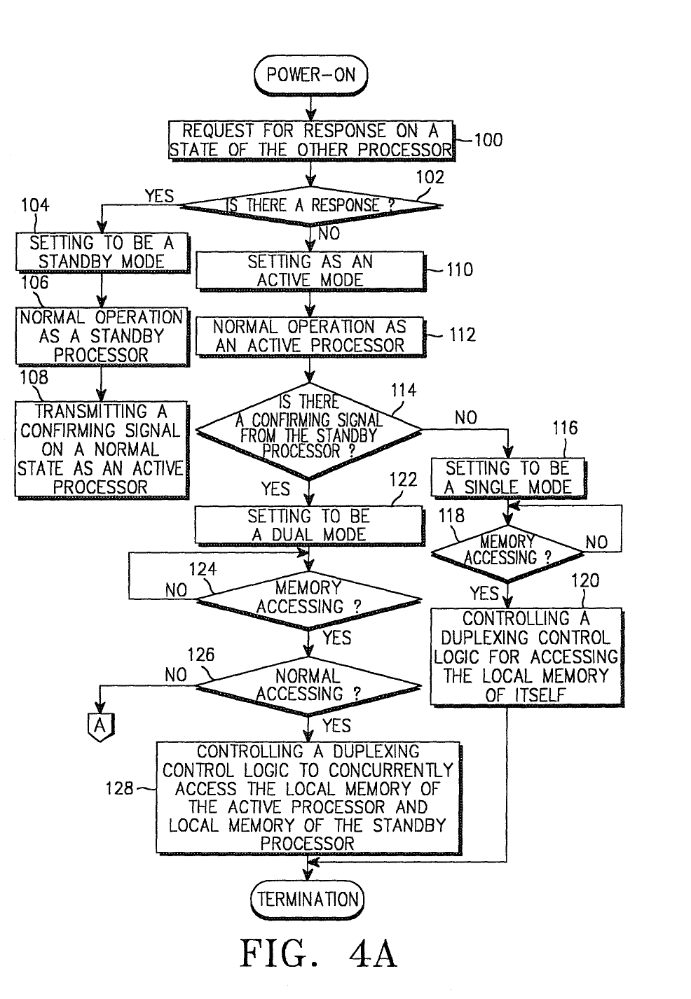

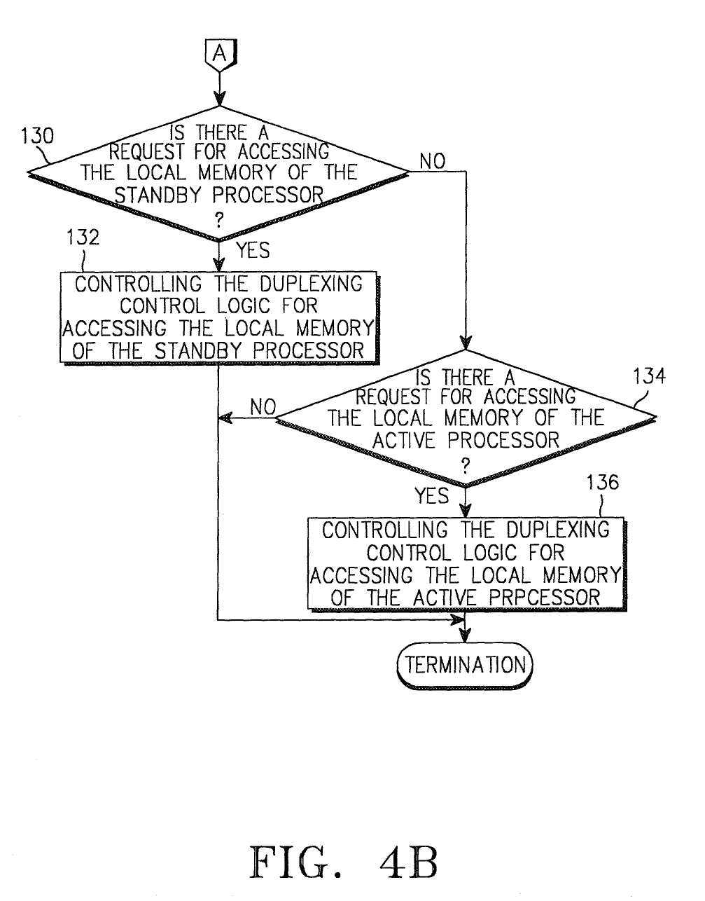

FIG. 4A and FIG. 4B illustrate a flow chart demonstrating a control method for duplexing according to an embodiment of the present invention.

The following is a detailed description of a duplexing operation according to an embodiment of the present invention. The following description assumes that the MPU 2a operates in an active mode, while the MPU 2b operates in a standby mode.

If the system is switched on, either one of the duplexed MPUs 2a, 2b is set in an active mode and the other is set in a standby mode by performing steps 100 through 112 in FIG. 4A. To be specific, if the system is switched on, each processor of the duplexed MPUs 2a, 2b requests a response on the state of the other processor by using the control channel C-CH. To exemplify a path of requesting a response on the state of the processor 10 of the MPU 2b by the processor 10 of the MPU 2a with reference to FIG. 2, the processor 10 of the MPU 2a requests a response on the state of the processor 10 of the MPU 2b via the local control buffer 14, the duplexing control buffer 20, the duplexing control buffer of the MPU 2b, and the local control buffer 14 of the MPU 2b.

Thereafter, the processor 10 determines in step 102 of FIG. 4A whether or not the other processor responds thereto. If there is no response, the processor 10 sets itself in an active mode in step 110, and normally operates as an active processor in step 112. This is to take an initiative as an active processor because the other processor has not yet been woke up. If there is a response, however, the processor 10 proceeds with step 104 to set itself in a standby mode because the other processor has taken an initiative as the active processor. In the subsequent step 106, the processor 10 normally operates as a standby processor. In step 108, the standby processor transmits a signal to the active processor to confirm that the standby processor is in normal operation.

Alternatively, under normal operation as an active processor, the processor 10 proceeds with step 114 to determine whether or not the standby processor has transmitted a confirming signal. The active processor 10 operates a watch-dog timer after a normal operation as an active processor in step 112. In the absence of a confirming signal from the standby processor within the period set by the watch-dong timer, the active processor 10 forcibly terminates a cycle for checking reception of the confirming signal. This is to prevent any error or problem with the standby processor from affecting the active processor.

If no confirming signal is received from the standby processor in step 114 of FIG. 4A, the system is set to be a single mode in step 116. Otherwise, the system is set to be a dual mode in step 122.

If circumstances require the active processor 10 to perform a memory access after the system has been set to be a single mode in step 118, the active processor 10 of the active MPU 2a controls the duplexing control logic 12 to access the local memory 6a of itself in step 120.

If circumstances require the active processor 10 to perform a memory access after the system has been set to be a dual mode in step 122, the active processor 10 controls the duplexing control logic 12 to either concurrently access the local memory 6a of itself or the local memory 6b of the standby MPU 2b, or to access either one of them only. The above process is performed in steps 124 through 136 in FIG. 4A.

The following is a detailed description of a memory accessing operation by the active processor 10 after the system has been set to be in a dual mode.

The active processor 10 determines in step 124 of FIG. 4A whether or not the circumstances require memory accessing. In the affirmative, the active processor 10 proceeds with step 126 in FIG. 4A to determine whether the operating state is normal or abnormal. If normal, the active processor 10 controls the duplexing control logic 12 to concurrently access the local memory 6a of itself and the local memory 6b (not shown in FIG. 2) of the MPU 2b in step 128. The active processor 10 provides an address value for concurrently accessing the local memory 6a of itself and the local memory 6b of the standby MPU 2b to be within the range of “0x40000000˜0x43ffffff” for the duplexing control logic 12. If the address value within the range of “4x00000000˜0x43ffffff” is applied, the duplexing control logic 12 enables the local control buffer 14, the local address buffer 16, the local data buffer 18, the duplexing control buffer 20, the duplexing address buffer 22, and the duplexing data buffer 24 of the active MPU 2a as well as the duplexing control buffer 20, duplexing address buffer 22, and the duplexing data buffer 24 of the standby MPU 2b by using the data channel D-CH. As a result, the active processor 10 can concurrently access the local memory 6a of itself and the local memory 6b of the standby MPU 2b.

With the above operation, all the results processed by the active MPU 2a are transferred not only to the local memory 6a of itself but also to the standby MPU 2b so as to be written on the corresponding local memory 6b. Therefore, the local memories 6a, 6b of the active MPU 2a and the standby MPU 2b maintain the same data. This enables maintaining the current status without affecting operation of the system even if any trouble occurs in the active MPU 2a in the course of operating the system.

Meanwhile, if it is determined in step 126 of FIG. 4A that the memory accessing is not in a normal accessing state, step 130 in FIG. 4B is proceeded with to determine whether or not the circumstances require accessing the local memory 6b of the standby processor. Such a request for accessing may be used by the operator for testing duplexing.

If it is determined in step 130 of FIG. 4B that the circumstances require accessing local memory 6b of the standby processor, the active processor 10 controls the duplexing control logic 12 so as to access the local memory 6b (not shown in FIG. 2) of the standby MPU 2b only in step 132. Here, the active processor 10 provides an address value for accessing the local memory 6b of the standby MPU 2b only within the range of “0x80000000˜0x83ffffff” for the duplexing control logic 12. If the address value within the range of “0x80000000˜0x83ffffff” is applied, the duplexing control logic 12 enables the duplexing control buffer 20, the duplexing address buffer 22, and the duplexing data buffer 24 of the active MPU 2a, as well as the duplexing control buffer 20, the duplexing address buffer 22, and the duplexing data buffer 24 of the standby MPU 2b. An address value not within the range of “0x80000000˜0x83ffffff”, but within the range of “0x00000000˜0x03ffffff”, is buffered in the duplexing address buffer 22 of the active MPU 2a and the standby MPU 2b. As a result, the active processor 10 can access the local memory 6b of the standby MPU 2b. If the active processor 10 accesses the address within the range of “0x80000000˜0x83ffffff”, the local memory 6b of the standby MPU 2b can be directly accessed without affecting the local memory 6a of the active MPU 2a. At this stage, transmission and reception of data are performed by a between the active MPU 2a and the standby MPU 2b. If, however, the active MPU 2a fails to receive a confirming response due to the problem in the standby MPU 2b, the processor 10 operates the watch-dog timer of itself to be forcibly released from that state. The active processor 10 preferably has a duplexing state register for observing the duplexed state of the system. The processor 10 can acknowledge the state of the system by reading the register of the duplexed state.

Alternatively, if it is determined in step 130 of FIG. 4B that the circumstances do not request accessing of the local memory 6b of the standby processor, the active processor 10 proceeds with step 134 of FIG. 4B. In step 134, the active processor 10 determines whether the circumstances demand accessing the local memory 6a of itself only. In the affirmative, the active processor 10 controls the duplexing control logic 12 so as to access the local memory 6a of itself only in step 136. At this stage, the active processor 10 provides an address value for accessing the local memory 6a of itself only within the range of “0x00000000˜0x03ffffff” for the duplexing control logic 12. If the address value within the range of “0x00000000˜0x03ffffff” is applied, the duplexing control logic 12 enables the local control buffer 14, the local address buffer 16, the local data buffer 18 of the active MPU 2a. An address value within the range of “0x00000000˜0x03ffffff” is buffered in the local address buffer 16 of the active MPU 2a. As a consequence, the active processor 10 can access the local memory 6a of the active MPU 2a. If the active processor 10 updates the local memory 6a of itself by performing steps 134 through 136, it is preferable for the standby MPU 2b to request a duplication through the control channel C-CH. Upon reception of the request for duplication from the standby MPU 2b, the active processor 10 checks the current status of itself (the local memory access of the standby processor and the local memory access based on the request for duplication), and mediates the use of the data channel D-CH through the control channel C-CH.

As described above, the present invention has an effect of decreasing the load of applicable software, which becomes larger in its size and complicated in its structure by allowing the hardware and OS to concurrently access the memory of the duplexing processor in a large scale system of high reliability The present invention has further effects of maintaining the consistency of data as well as of rapidly realizing configuration and recovery of data with a minimized software load while realizing a superior failure tolerance in the system and minimizing deterioration of system performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A duplexing method in a system duplexed into a first unit and a second unit, the first unit including a first processor and a first local memory, and the second unit including a second processor and a second local memory, the method comprising the steps of:
providing a duplexing channel for concurrently accessing and selectively accessing the first local memory and the second local memory between the first unit and the second unit;
providing a duplexing control logic section accessible to the first local memory and the second local memory through the duplexing channel; and
concurrently accessing the first local memory and the second local memory through the duplexing channel by the duplexing control logic section based on a request for memory accessing by an active processor, which is one of the first processor and the second processor.

2. The duplexing method of claim 1, wherein the duplexing channel comprises:
a data channel for transmitting data, an address thereof, and a related control signal while concurrently writing in the first local memory and the second local memory; and
a control channel for active/standby negotiation and exchange of information between the duplexed first and second units, and for transmitting and receiving signals informing of a status of the first and the second units, a status of duplexed connection, and signals informing start and termination of a duplexing cycle for control in a hardware like manner after the negotiation of duplexing.

3. A duplexing method in a system duplexed into a first unit and a second unit, the first unit and the second unit including a first local memory and a second local memory, respectively, the method comprising the steps of:
mutually requesting responses on a status of each other between a first processor and a second processor included in the first unit and the second unit, respectively;
operating as an active processor if no response is received from the other processor;
operating as a standby processor if a response is received from the other processor;
transmitting a confirming signal by the standby processor to inform the active processor of a normal operation of the standby processor; and
concurrently and selectively accessing the first local memory and the second local memory by the active processor in accordance with reception of the confirming signal if there is a request for memory access.

4. The duplexing method of claim 3, characterized by concurrently accessing the first local memory and the second local memory if there is a request for memory access after the active processor receives the confirming signal informing that the standby processor is in a normal operation state.

5. A duplexing method in a large scale system including duplexed first and second units with identical construction, the first unit including a first processor and a first local memory, and the second unit including a second processor and a second local memory, comprising:
a duplexing channel for concurrently and selectively accessing the first local memory and the second local memory between the first and the second units; and
a duplexing control logic section for concurrently and selectively accessing the first local memory and the second local memory through the duplexing channel based on a request for memory access by an active processor, which is either the first processor or the second processor.

6. The duplexing method of claim 5, wherein the duplexing channel comprises:
a data channel for transmitting data, which is transmitted by the duplexing control logic section when concurrently writing in the first local memory and the second local memory, an address thereof and a related control signal; and
a control channel used by the first processor and the second processor for active/standby negotiation and exchange of information between the duplexed first and second units, and for transmitting and receiving signals informing status of the first and the second units, signals informing status of duplexed connection, and signals informing start and termination of a duplexing cycle for control in a hardware like manner after negotiation of duplexing.

7. The duplexing method of claim 5, further comprising:
local buffers respectively included in the duplexed first and second units for buffering a control signal, an address and data used for accessing the local memory thereof; and
local buffers respectively included in the duplexed first and second units for buffering a control signal, an address and data for accessing the duplexed other local memory.
